(19) United States
(12) Patent Application Publication
(10) Pub. No.: US 2024/0277071 A1
(43) Pub. Date: Aug. 22, 2024

(54) AEROSOL GENERATING DEVICE AND METHOD OF CONTROLLING THE SAME

(71) Applicant: KT&G CORPORATION, Daejeon (KR)

(72) Inventors: Yong Hwan KIM, Anyang-si (KR); Young Bum KWON, Yongin-si (KR); Dong Sung KIM, Seoul (KR); Hun II LIM, Seoul (KR)

(73) Assignee: KT&G CORPORATION, Daejeon (KR)

(21) Appl. No.: 18/413,200

(22) Filed: Jan. 16, 2024

(30) Foreign Application Priority Data
Feb. 21, 2023 (KR) 10-2023-0023190
May 2, 2023 (KR) 10-2023-0057350

(51) Int. Cl. A24F 40/53; A24D 1/20; A24F 40/20; A24F 40/51; A24F 40/57; H05B 1/02

(52) U.S. Cl. CPC A24F 40/53; A24D 1/20; A24F 40/20; A24F 40/51; A24F 40/57; H05B 1/0227

(57) ABSTRACT

Provided are an aerosol generating device and a method of controlling the same. When a cigarette is inserted into an aerosol generating device, a heater assembly is used to heat the cigarette to generate an aerosol in a preheating section and a smoking section after the preheating section, a temperature sensor is used to sense a temperature of the heater assembly in the preheating section and the smoking section, and a controller is used to identify a cigarette type of the cigarette, based on a trend in a temperature change within a preset temperature range of the preheating section, and control heating of the heater assembly during the smoking section by using a temperature profile corresponding to the identified cigarette type.

### CROSS-REFERENCE TO RELATED APPLICATIONS

This application is based on and claims priority under 35 U.S.C. § 119 to Korean Patent Application Nos. 10-2023-0023190, filed on Feb. 21, 2023, and 10-2023-0057350, filed on May 2, 2023, in the Korean Intellectual Property Office, the disclosures of which are incorporated by reference herein in their entireties.

### BACKGROUND

### 1. Field

The disclosure relates to an aerosol generating device and a method of controlling the aerosol generating device, and more particularly, to identifying a type of a cigarette inserted into an aerosol generating device and controlling heating of a heater with a temperature profile corresponding to the type of the inserted cigarette.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted. To enhance the smoking experience of a user, research has been actively conducted on various methods to control the heating of a heater, which are optimized for a cigarette inserted into an aerosol generating device.

### SUMMARY

Provided are an aerosol generating device and a method of controlling the same, wherein the aerosol generating device identifies a type of a cigarette inserted into the aerosol generating device and controls the heating of a heater with a temperature profile corresponding to the type of the inserted cigarette, in order to solve an issue regarding the unsatisfactory smoking experience of a user that results from the failure of heating optimized for a cigarette type, the failure occurring when a heater is controlled with a single temperature profile without considering a cigarette type. The technical problems of the disclosure are not limited to the aforementioned description, and other technical problems may be derived from the embodiments described hereinafter.

Additional aspects will be set forth in part in the description which follows and, in part, will be apparent from the description, or may be learned by practice of the presented embodiments of the disclosure.

According to an embodiment, an aerosol generating device includes a heater assembly configured to, when a cigarette is inserted into the aerosol generating device, heat the cigarette to generate an aerosol during a preheating section and a smoking section after the preheating section, a temperature sensor configured to sense a temperature of the heater assembly in the preheating section and the smoking section, and a controller configured to identify a cigarette type of the cigarette, based on a trend in a temperature change detected within a preset temperature range of the preheating section and control heating of the heater assembly during the smoking section by using a temperature profile corresponding to the identified cigarette type.

According to another embodiment, a method of controlling an aerosol generating device includes, when a cigarette is inserted into the aerosol generating device, controlling preheating of a heater assembly in a preheating section, sensing a temperature of the heater assembly within a preset temperature range of the preheating section, identifying a cigarette type of the cigarette, based on a trend in a temperature change detected within the preset temperature range, and controlling heating of the heater assembly in a smoking section by using a temperature profile corresponding to the identified cigarette type.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A shows an aerosol generating system according to an embodiment;

FIG. 1B shows an aerosol generating system according to another embodiment;

FIGS. 2A to 2C show cigarettes of different types according to an embodiment;

FIG. 3 is a block diagram showing hardware components of an aerosol generating device, according to an embodiment;

FIG. 4 is a diagram for explaining a temperature profile for controlling the heating of a heater assembly, according to an embodiment;

FIG. 5 is a diagram for explaining a method of identifying a cigarette type within a preset temperature range in a preheating section, according to an embodiment;

FIG. 6 is a diagram for explaining a method of calculating a gradient value corresponding to a trend in a temperature change within a preset temperature range in a preheating section, according to an embodiment;

FIG. 7 is a diagram for explaining that gradient values differ depending on cigarette types within a preset temperature range in a preheating section, according to an embodiment;

FIG. 8 is a diagram for explaining a method of identifying a cigarette type by using a gradient value corresponding to a trend in a temperature change, according to an embodiment;

FIG. 9 is a diagram for explaining that the heating of a heater assembly is controlled in a smoking section by using a temperature profile corresponding to an identified cigarette type, according to an embodiment;

FIG. 10 is a detailed flowchart of a method of controlling an aerosol generating device, according to an embodiment; and

FIG. 11 is a flowchart of a method of controlling an aerosol generating device, according to an embodiment.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

Hereinafter, the embodiments will now be described more fully with reference to the accompanying drawings, in which exemplary embodiments are shown such that one of ordinary skill in the art may easily work the embodiments. The embodiments can, however, be embodied in many different forms and should not be construed as being limited to the embodiments set forth herein.

Hereinafter, embodiments will be described in detail with reference to the drawings.

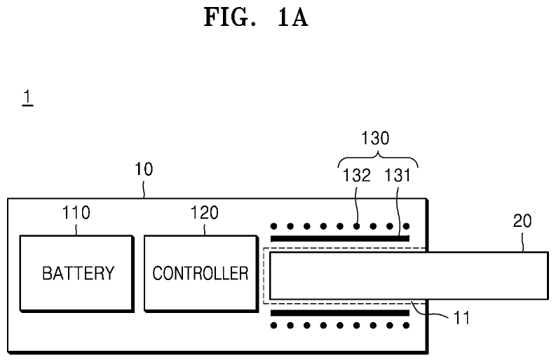

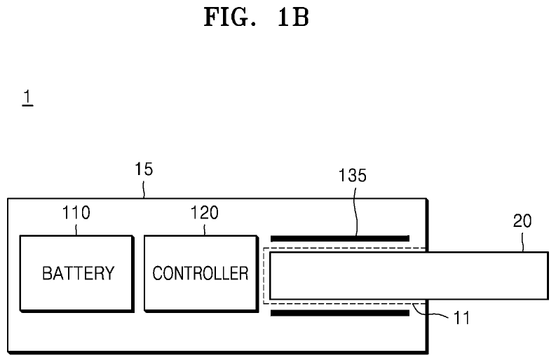

FIG. 1A shows an aerosol generating system according to an embodiment.

Referring to FIG. 1A, the aerosol generating system 1 may include an aerosol generating device 10 and an aerosol generating article 20. Hereinafter, the aerosol generating article 20 may be referred to as a cigarette.

The aerosol generating device 10 may include a cavity 11 that is an insertion space (or an accommodation space) into which the aerosol generating article 20 is inserted and may generate aerosols by heating the aerosol generating article 20 inserted into the cavity 11. The aerosol generating article 20 may be a sort of an aerosol generating substrate and include an aerosol generating material.

The aerosol generating device 10 may include a battery 110, a controller 120, and a heating portion 130. The heating portion 130 may be referred to as a heater assembly. The heating portion 130 may be a heater assembly that heats the aerosol generating article 20 by using various heating methods, for example, a resistance heating method, an induction heating method, a dielectric heating method, or an ultrasonic heating method. When the heating portion 130 heats the aerosol generating article 20 in the induction heating method, the heating portion 130 may include a susceptor 131 and an induction coil 132. Hereinafter, an example in which the heating portion 130 heats the aerosol generating article 20 in the induction heating method is described, but one or more embodiments are not limited thereto.

However, the internal structure and arrangement of the aerosol generating device 10 are not limited to those illustrated in FIG. 1. According to the design of the aerosol generating device 10, it will be understood by one of ordinary skill in the art that some of the hardware components illustrated in FIG. 1 may be omitted or new components may be added and that respective hardware components may be variously arranged.

The aerosol generating device 10 may generate aerosols by heating the aerosol generating article 20 accommodated in the aerosol generating device 10, according to an induction heating method. The induction heating method may indicate a method by which a magnetic substance is heated by applying an alternating magnetic field, of which a direction periodically changes, wherein the magnetic substance is heated by an external magnetic field.

When the alternating magnetic field is applied to the magnetic substance, energy may be lost in the magnetic substance because of eddy current loss and hysteresis loss, and the lost energy may be emitted from the magnetic substance as heat energy. The greater an amplitude or a frequency of an alternating magnetic field applied to a magnetic substance is, the more heat energy may be emitted from the magnetic substance. The heat energy may be emitted from the magnetic substance as the aerosol generating device 10 applies the alternating magnetic field to the magnetic substance, and the heat energy emitted from the magnetic substance may be transferred to the aerosol generating article 20.

The magnetic substance heated by the external magnetic field may be a susceptor material. The susceptor 131 may be included in the aerosol generating device 10 in the form of pieces, flakes, or strips. For example, at least some portions of the susceptor 131 inside the aerosol generating device 10 may include a susceptor material.

At least part of the susceptor material may include a ferromagnetic substance. For example, the susceptor material may include metal or carbon. The susceptor material may include at least one of ferrite, ferromagnetic alloy, stainless steel, and aluminum (Al). Also, the susceptor material may include at least one of ceramic, such as graphite, molybdenum (Mo), silicon carbide, niobium (Nb), nickel (Ni) alloy, a metal film, or zirconia, transition metal, such as Ni or cobalt (Co), and metalloid, such as boron (B) or phosphorus (P).

The susceptor 131 may have a tube shape or a cylindrical shape and may be arranged outside the susceptor 131 to surround the cavity 11 into which the aerosol generating article 20 is inserted. Therefore, when the aerosol generating article 20 is inserted into the cavity 11 of the aerosol generating device 10, the susceptor 131 may be arranged outside the aerosol generating article 20 to surround the same. Accordingly, because of heat transmitted from the susceptor 131, the temperature of the aerosol generating material in the aerosol generating article 20 may increase.

The induction coil 132 may be configured to apply the alternating magnetic field to the susceptor 131. When power is supplied from the aerosol generating device 10 to the induction coil 132, a magnetic field may be generated in the induction coil 132. When an alternating current is applied to the induction coil 132, a direction of the magnetic field formed in the induction coil 132 may gradually change. When the susceptor 131 is exposed to the alternating magnetic field located inside the induction coil 132 and having a periodically changing direction, the susceptor 131 may emit heat, and thus, the aerosol generating article 20 accommodated in the cavity 11 may be heated.

The induction coil 132 may be wound along an outer side surface of the susceptor 131. Also, the induction coil 132 may be wound along an inner surface of an external housing of the aerosol generating device 10. The susceptor 131 may be located in an inner space formed as the induction coil 132 is wound. When power is supplied to the induction coil 132, the alternating magnetic field generated by the induction coil 132 may be applied to the susceptor 131.

The induction coil 132 may extend in a lengthwise direction of the aerosol generating device 10. The induction coil 132 may extend to an appropriate length in the lengthwise direction. For example, the induction coil 132 may extend to a length corresponding to the length of the susceptor 131 or a length that is greater or less than the length of the susceptor 131.

The induction coil 132 may be arranged at a location appropriate to apply the alternating magnetic field to the susceptor 131. The efficiency of applying the alternating magnetic field of the induction coil 132 to the susceptor 131 may differ according to the size, length, or arrangement of the induction coil 132.

When the amplitude or frequency of the alternating magnetic field formed by the induction coil 132 is changed, a heating degree (e.g., the temperature of the susceptor 131) of the susceptor 131 is changed, and thus, a degree at which the aerosol generating article 20 is heated by the susceptor 131 may also be changed. Because the amplitude or frequency of the magnetic field generated by the induction coil 132 may be changed by the power applied to the induction coil 132, the aerosol generating device 10 may control the heating of the aerosol generating article 20 by adjusting the power applied to the induction coil 132. For example, the aerosol generating device 10 may control the amplitude and frequency of the alternating current applied to the induction coil 132.

As an example, the induction coil 132 may be realized as a solenoid. The induction coil 132 may be a solenoid wound along the inner surface of the external housing of the aerosol generating device 10, and the susceptor 131 and the aerosol generating article 20 may be located in the inner space of the solenoid. Materials of a conducting wire forming the solenoid may include copper (Cu). However, the materials are not limited thereto. The materials of the conducting wire forming the solenoid may include any one of silver (Ag), gold (Au), Al, tungsten (W), zinc (Zn), and Ni, or an alloy including at least one of the above-listed materials.

The battery 110 may supply power to the induction coil 132. The battery 110 may be a lithium iron phosphate (LiFePO₄) battery, but is not limited thereto. For example, the battery 110 may be a lithium cobalt oxide (LiCoO₂) battery, a lithium titanate battery, a lithium polymer (LiPoly) battery, or the like.

The controller 120 may control the power supplied to the induction coil 132 and control general functions and operations of the aerosol generating device 10. The controller 120 may control the power, which is supplied from the battery 110 to the induction coil 132, to be adjusted. For example, the controller 120 may control the power supplied to the induction coil 132 such that the susceptor 131 may reach a target temperature on the temperature profile or maintain the target temperature.

Although not illustrated in FIGS. 1A and 1B, the aerosol generating device 10 and an additional cradle may form together a system. For example, the cradle may be used to charge the battery 110 of the aerosol generating device 10. Alternatively, the induction coil 132 may be heated when the cradle and the aerosol generating device 10 are coupled to each other.

FIG. 1B shows an aerosol generating system according to another embodiment.

An aerosol generating device 15 of FIG. 1B includes a heating portion 135 in another heating method, compared to the aerosol generating device 10 of FIG. 1A.

When the aerosol generating article 20 is inserted into the aerosol generating device 15, the heating portion 135 may be a heater assembly in an external heating method which is heated by the power from the battery 110 to heat the exterior of the aerosol generating article 20. Therefore, the heating portion 135 may be realized as a tubular or circular configuration.

The heating portion 135 may include an electro-resistive heater. For example, the heating portion 135 may include an electrically conductive track and may be heated when currents flow through the electrically conductive track.

That is, FIGS. 1A and 1B are diagrams for explaining an example of aerosol generating devices including a heater assembly of an external heating method that heats the exterior of the aerosol generating article (that is, the cigarette). The present embodiment described below may be easily modified and implemented in the aerosol generating devices 10 and 15 of FIGS. 1A and 1B. The present embodiment may also be implemented as an aerosol generating device employing an external heating method that is different from the methods described with reference to FIGS. 1A and 1B.

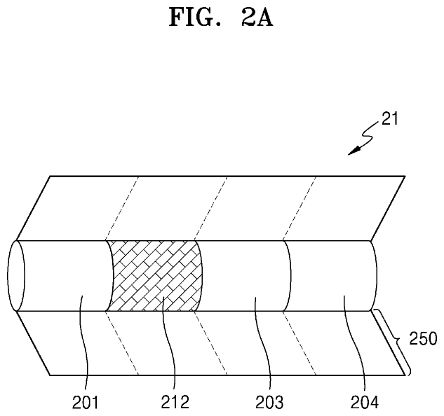

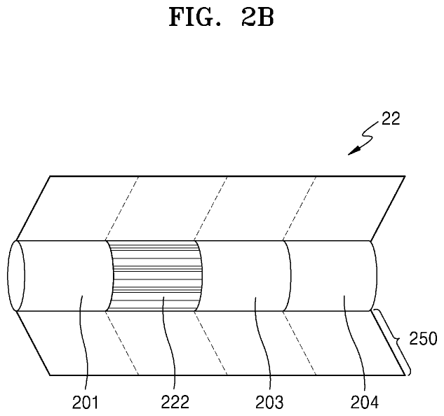

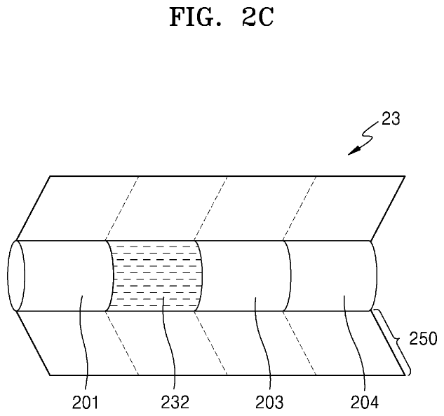

FIGS. 2A to 2C show cigarettes of different types according to an embodiment.

Referring to FIGS. 2A to 2C, a cigarette 21, 22, or 23 may correspond to the aerosol generating article 20 of FIGS. 1A and 1B. The cigarette 21, 22, or 23 may be divided into a first portion 201, a second portion 212, 222, or 232, a third portion 203, and a fourth portion 204, and the first portion 201, the second portion 212, 222, or 232, the third portion 203, and the fourth portion 204m may include an aerosol generating element, a tobacco medium element, a cooling element, and a filter element, respectively. In detail, the first portion 201 may include an aerosol generating material, the second portion 212, 222, or 232 may include a tobacco material and a moisturizer, the third portion 203 may include a medium for cooling airflow passing through the first portion 201 and the second portion 212, 222, or 232, and the fourth portion 204 may include a filter material.

The first portion 201, the second portion 212, 222, or 232, the third portion 203, and the fourth portion 204 may be sequentially aligned in the lengthwise direction of the cigarette 21, 22, or 23. Here, the lengthwise direction may be a direction in which the length of the cigarette 21, 22, or 23 extends and a direction from the first portion 201 to the fourth portion 204. Accordingly, an aerosol generated from at least one of the first portion 201 and the second portion 212, 222, or 232 may form airflow by sequentially passing through the first portion 201 to the fourth portion 204, and accordingly, a user may inhale the aerosol from the fourth portion 204.

The first portion 201 may include an aerosol generating element. The first portion 201 may contain other additives, such as flavors, a wetting agent, and/or organic acid, and include a flavoring liquid, such as menthol or a moisturizer, as aerosol generating elements. Here, the aerosol generating element may include, for example, at least one of glycerin, propylene glycol, ethylene glycol, dipropylene glycol, diethylene glycol, triethylene glycol, tetraethylene glycol, and oleyl alcohol.

The first portion 201 may include a crimped sheet, and the aerosol generating element may be included in the first portion 201 while impregnated in the crimped sheet. Also, while absorbed into the crimped sheet, other additives, such as flavors, a wetting agent, and/or organic acid, and a flavoring liquid may be included in the first portion 201. The crimped sheet may be a sheet including a polymer material. For example, the polymer material may include at least one of paper, cellulose acetate, lyocell, and polylactic acid. For example, the crimped sheet may be a paper sheet that, even when heated at a high temperature, does not produce a heat-induced odor. However, one or more embodiments are not limited thereto.

The first portion 201 may extend from an end portion of the cigarette 21, 22, or 23 to a point of about 7 mm to about 20 mm, and the second portion 212, 222, or 232 may extend from the end of the first portion 201 to the point of about 7 mm to about 20 mm. However, one or more embodiments are not limited to the numerical ranges stated above, and the length to which each of the first portion 201 and the second portion 212, 222, or 232 extends may be appropriately adjusted within a range that may be easily modified by one of ordinary skill in the art.

The second portion 212, 222, or 232 may include a tobacco medium element. Cigarette types may be distinguished depending on which tobacco medium is included in the second portion 21, 222, or 232.

In detail, with reference to FIG. 2A, the second portion 212 included in the cigarette 21 may include a filter material impregnated with a nicotine liquid. Here, the nicotine liquid may correspond to a nicotine solution including a tobacco-containing material having a volatile tobacco flavor component, or a solution to which nicotine salts are added. The filter material may include a fiber bundle in which cellulose acetate fiber strands are aggregated, or a rolled paper sheet. That is, the cigarette 21 may correspond to a cigarette type in which the second portion 212 includes a tobacco medium including the filter material impregnated with the nicotine liquid.

Referring to FIG. 2B, the second portion 222 included in the cigarette 22 may include a plurality of tobacco granules. The tobacco granules may be buried between filter materials. The filter material may include a fiber bundle in which cellulose acetate fiber strands are aggregated, or a rolled paper sheet. The tobacco granules may be evenly distributed between the cellulous acetate fibers, or in the rolled paper sheet, the tobacco granules may be evenly distributed. That is, the cigarette 22 corresponds to the cigarette type in which the second portion 222 includes the tobacco medium of the tobacco granules.

Referring to FIG. 2C, the second portion 232 included in the cigarette 23 may include tobacco bits, tobacco particles, a tobacco sheet, or the like. That is, the cigarette 23 corresponds to the cigarette type in which the second portion 232 includes a solid tobacco material, such as tobacco leaves, tobacco leaf veins, an expanded tobacco, cut tobacco bits, sheet tobacco bits, or a reconstituted tobacco.

The third portion 203 may include the medium that cools airflow passing through the first portion 201 and the second portion 212, 222, or 232. The third portion 203 may be formed of a polymer material or a biodegradable polymer material and have a cooling function. For example, the third portion 203 may be formed of polylactic acid (PLA) fibers, but one or more embodiments are not limited thereto. Alternatively, the third portion 203 may include a cellulose acetate filter including therein a plurality of holes. However, the third portion 203 is not limited thereto, and any material having an aerosol cooling function may be used. For example, the third portion 203 may be a tube filter or a paper tube including a hollow.

The fourth portion 204 may include a filter material. For example, the fourth portion 204 may include a cellulose acetate filter. Shapes of the fourth portion 204 are not limited. For example, the fourth portion 204 may include a cylinder-type rod or a tube-type rod having a hollow inside. Also, the fourth portion 204 may include a recess-type rod. When the fourth portion 204 includes a plurality of segments, at least one of the plurality of segments may have a different shape.

The fourth portion 204 may be formed to generate flavors. For example, a flavoring liquid may be injected onto the fourth portion 204, or an additional fiber coated with the flavoring liquid may be inserted into the fourth portion 204.

The cigarette 21, 22, or 23 may include a wrapper 250 surrounding at least some of the first portion 201 to the fourth portion 204. Also, the cigarette 21, 22, or 23 may include a wrapper 250 surrounding all of the first portion 201 to the fourth portion 204. The wrapper 250 may be located on the outermost portion of the cigarette 21, 22, or 23, and the wrapper 250 may be a single wrapper, but may be a combination of wrappers.

The wrapper 250 may include a heat conductive material. For example, the heat conductive material may be metal foil, such as Ag foil paper, Al foil paper, or Cu foil paper, but one or more embodiments are not limited thereto. The heat conductive material included in the wrapper 250 may uniformly distribute heat transmitted to the first portion 201 and the second portion 212, 222, or 232, and thus, the heat conductivity may be increased, and taste of the tobacco may be improved. The heat conductive material included in the wrapper 250 may function as a susceptor.

The heat conductive material in the wrapper 250 may be used as an electromagnetic inductor for detecting a cigarette. The heat conductive material in the wrapper 250 may change an inductance of a cigarette detecting medium. Based on the detected inductance change, the aerosol generating device (10 of FIG. 1) may determine whether the cigarette 21, 22, or 23 is inserted into or removed from the aerosol generating device 10.

Three types of cigarettes shown in FIGS. 2A to 2C are used as examples in the present embodiment, but in the aerosol generating system 1, various cigarettes other than the cigarette types including the tobacco medium elements of FIGS. 2A to 2C may be used. In addition, in the present embodiment, the cigarette 21, 22, or 23 is described as a structure divided into four portions, but is not limited thereto. The cigarette may be implemented as different cigarette structures including tobacco medium elements.

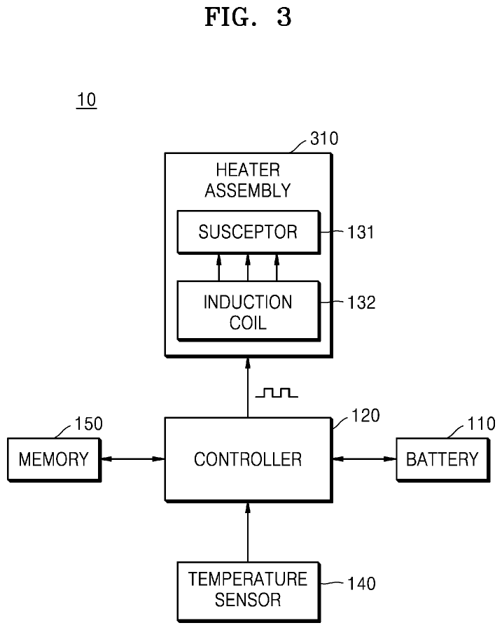

FIG. 3 is a block diagram showing hardware components of an aerosol generating device, according to an embodiment.

Referring to FIG. 3, the aerosol generating device 10 may include a battery 110, a controller 120, a susceptor 131, an induction coil 132, a temperature sensor 140, and a memory 150. FIG. 3 illustrates components of an aerosol generating device 10 which are related to the present embodiment. However, it will be understood by one of ordinary skill in the art related to the present embodiment that other general-purpose components may be further included in the aerosol generating device 10, in addition to the components illustrated in FIG. 3. The operations of the aerosol generating device 10 of FIG. 1 may also be applied to the aerosol generating device 10 of FIG. 3.

The battery 110 may supply power to be used for the aerosol generating device 10 to operate. That is, the battery 110 may supply the power to the induction coil 132 to heat the susceptor 131. In addition, the battery 110 may supply the power required for operations of other components of the aerosol generating device 10, that is, the controller 120, the heater assembly 310, the temperature sensor 140, and the memory 150. The battery 110 may be a rechargeable battery or a disposable battery.

As a hardware component including at least one processor, the controller 120 controls general operations of the aerosol generating device 10.

The heater assembly 310 includes the susceptor 131 and the induction coil 132. The heater assembly 310 generates an aerosol by using the susceptor 131 arranged to induce-heat the periphery of the aerosol generating article 20 (or the cigarette 21, 22, or 23 of FIGS. 2A to 2C) accommodated in the aerosol generating device 10. In this case, the controller 120 may control power supplied to the heater assembly 310 according to pulse width modulation (PWM). In an embodiment, the controller 120 may include a separate integrated circuit (IC) for controlling only the power supply to the induction coil 132.

The temperature sensor 140 may sense the temperature of the heater assembly 310 (specifically, the susceptor 131). The temperature sensor 140 may directly contact the susceptor 131 and measure the temperature thereof. Alternatively, the temperature sensor 140 may be located around the susceptor 131 to sense an ambient temperature of the susceptor 131, thus indirectly measuring the temperature of the susceptor 131. For example, the temperature sensor 140 may be implemented using various temperature methods, such as resistance measurement, current measurement, thermocouples, and thermistors (NTC).

The temperature sensor 140 may be arranged to sense not the temperature of the heater assembly 310 but the temperature of the cigarette 21, 22, or 23. Hereinafter, it is described that the temperature sensor 140 senses the temperature of the heater assembly 310, but one or more embodiments are not limited thereto. The temperature sensor 140 may be modified to sense the temperature of the cigarette 21, 22, or 23 in the embodiments below.

The controller 120 may control the temperature of the susceptor 131, based on temperature information detected by the temperature sensor 140. According to preset temperature profiles, the controller 120 may control power supplied to the induction coil 132 to maintain the temperature of the susceptor 131 to a target temperature.

The memory 150 is a hardware component that stores various types of data processed by the aerosol generating device 10, and may store data processed and data to be processed by the controller 120. The memory 150 may include various types of memories, for example, random access memory (RAM), such as dynamic random access memory (DRAM) or static random access memory (SRAM), read-only memory (ROM), electrically erasable programmable read-only memory (EEPROM), etc.

In the memory 150, different kinds of data, such as various pieces of analysis data for identifying the type of the aerosol generating article 20 and temperature profiles corresponding to the type of the aerosol generating article 20, which are used for the aerosol generating device to operate may be stored.

The aerosol generating device 10 may further include a cigarette detecting element. The cigarette detecting element may detect whether the aerosol generating article 20 is inserted into the aerosol generating device 10 (that is, the cavity 11). Alternatively, the cigarette detecting element may detect the removal of the aerosol generating article 20. The cigarette detecting element may be realized as a inductive sensor, a capacitance sensor, an optical sensor, a resistive sensor, and the like. When the insertion of the aerosol generating article 20 is detected, the controller 120 may control the aerosol generating device 10 to automatically initiate a heating operation without an additional external input. However, the present embodiment is not limited thereto, and the aerosol generating device 10 may not include the cigarette detecting element, and in this case, the controller 120 may control the aerosol generating device 10 to initiate a heating operation only through an additional external user input.

The aerosol generating device 10 according to the present embodiment may identify a cigarette type of the cigarette 21, 22, or 23 inserted into the aerosol generating device 10 and control the heating of the heater assembly 310 by using a temperature profile corresponding to the identified cigarette type. For example, the cigarette types that may be used in the aerosol generating device 10 may be the cigarettes 21, 22, and 23 described above with reference to FIGS. 2A to 2C. However, those cigarette types are merely examples, and different cigarette types may also be used.

Different types of tobacco medium elements are included in the cigarettes 21, 22, and 23, and thus, the vaporization temperatures of respective tobacco medium elements may differ. Therefore, the optimized heating temperature range for aerosol generation to provide an appropriate smoking sensation may vary for each cigarette 21, 22, or 23. In other words, the temperature profile optimized for each cigarette type may vary.

The aerosol generating device 10 according to the present embodiment identifies a temperature change characteristic in a preheating section of the temperature profile to distinguish the cigarette type.

In detail, the controller 120 determines a trend in the temperature change in the preheating section, based on a period of time during which the temperature of the heater assembly 310 is increased from a first temperature to a second temperature. Here, the trend in the temperature change may be distinguished according to the type of the tobacco medium element included in the cigarette 21, 22, or 23. Then, the controller 120 may identify the cigarette type by determining which of the gradient values, which are distinguished for each cigarette type, the gradient value corresponding to the trend in the temperature change falls within.

When the cigarette type is identified, the controller 120 uses a temperature profile corresponding to the identified cigarette type to control the heating of the heater assembly 310 in smoking section after the preheating section. Accordingly, the aerosol generating device 10 may generate an aerosol by performing the heating operation by using the temperature profile optimized for each cigarette type and thus may provide an optimum smoking sensation to the user.

Hereinafter, a method, by which the aerosol generating device 10 identifies a cigarette type and applies a temperature profile optimized for the identified cigarette type, is described in more detail.

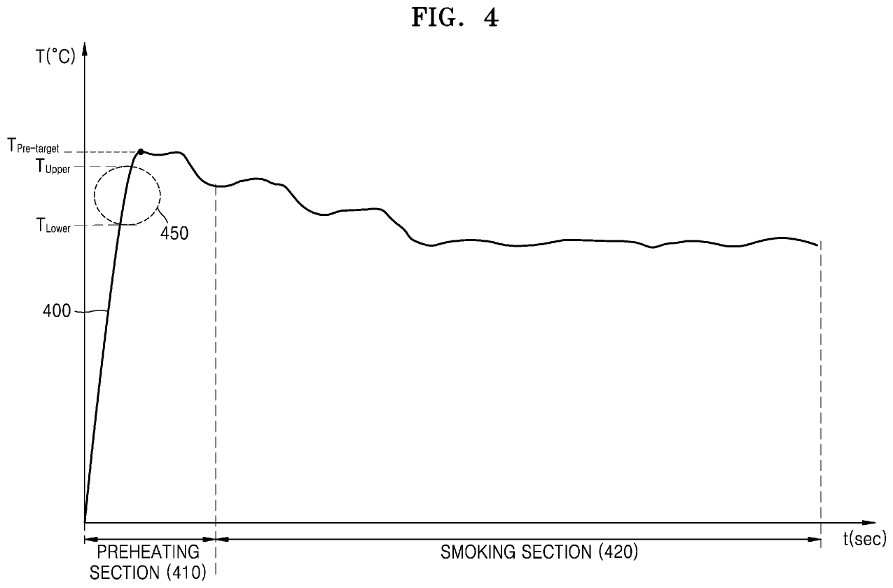

FIG. 4 is a diagram for explaining a temperature profile for controlling the heating of a heater assembly, according to an embodiment.

Referring to FIG. 4, a temperature profile 400 indicates a temperature change of the heater assembly 310 from a point in time, when the heating of the heater assembly 310 is initiated, to a point in time, when the heating of the heater assembly 310 is terminated. The temperature change defined in the temperature profile 400 is a preset value, and the controller 120 controls the actual temperature of the heater assembly 310 to align with the temperature specified in the temperature profile 400.

The temperature profile 400 includes a preheating section 410 and a smoking section 420.

The preheating section 410 refers to a section in which the temperature of the heater assembly 310 is controlled to reach a target preheating temperature T_{Pre-target} fast as a significant amount of power is instantaneously supplied from the battery 110 to the heater assembly 310 after the heating of the heater assembly 310 is initiated. Therefore, in the preheating section 410, the temperature of the heater assembly 310 drastically changes until the temperature reaches the target preheating temperature T_{Pre-target}.

The smoking section 420 refers to a section in which the user smokes while performing a series of puffs after the preheating is terminated (that is, after the preheating section).

The method by which the temperature changes in the preheating section 410 and the smoking section 420 of the temperature profile 400 of FIG. 4 is merely an example, but one or more embodiments are not limited thereto. For example, in the smoking section 420, the temperature is not gradually reduced, but decreases to a certain point in time and increases again. That is, the present embodiment is not limited to the temperature profile 400 of FIG. 4, and a temperature profile including other temperature changes may also be used.

The controller 120 may identify the cigarette type, based on a temperature change trend regarding temperatures of the heater assembly 310 in a preset temperature range 450 of the preheating section 410, the temperatures being detected by the temperature sensors 140. Here, the preset temperature range 450 is a range between a lower temperature limit T_{Lower} and an upper temperature limit T_{Upper}, and the upper temperature limit T_{Upper} of the temperature range 450 corresponds to a temperature lower than the target preheating temperature T_{Pre-target}.

It is advisable to set the preset temperature range 450 to be lower than the target preheating temperature T_{Pre-target}. For example, it may be advisable to set the upper temperature limit T_{Upper} of the preset temperature range 450 to be about 5° C. to about 10° C. lower than the target preheating temperature T_{Pre-target}, but one or more embodiments are not limited thereto. For example, it is advisable to define the preset temperature range 450 as a range including temperatures measured after a certain period of time (e.g., 30 seconds, 60 seconds, etc.) has passed after the preheating is initiated. This is because the temperature dramatically increases immediately after the initiation of the preheating and thus the trend in the temperature change is not distinguishable for each cigarette type.

The controller 120 may identify the cigarette type by determining the trend in the temperature change in the preset temperature range 450 in the preheating section 410 and control the heating of the heater assembly 310 by using the temperature profile corresponding to the identified cigarette type in the smoking section 420.

Until the temperature reaches the upper temperature limit T_{Upper} of the preset temperature range in the preheating section, the controller 120 controls the preheating of the heater assembly 310 by supplying preset power to the heater assembly 310 regardless of the cigarette type.

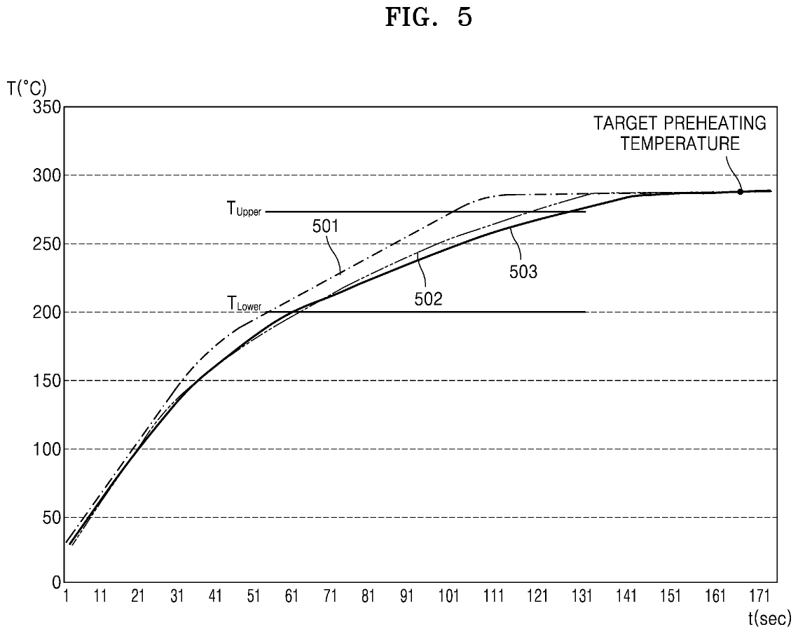

FIG. 5 is a diagram for explaining a method of identifying a cigarette type within a preset temperature range in a preheating section, according to an embodiment.

Referring to FIG. 5, the preset temperature range is a range from the lower temperature limit T_{Lower} to the upper temperature limit T_{Upper}. For example, the lower temperature limit T_{Lower} may be about 200° C., and the upper temperature limit T_{Upper} may be about 270° C. The target preheating temperature T_{Pre-target} in the preheating section may be about 285° C., and the upper temperature limit T_{Upper} in the preset temperature range is lower than the target preheating temperature T_{Pre-target}. However, the values of the lower temperature limit T_{Lower}, the upper temperature limit T_{Upper}, and the target preheating temperature T_{Pre-target} are merely examples, and one or more embodiments are not limited thereto. The temperature values may be variously modified according to temperature profiles to be used.

In the preset temperature range in the preheating section, the trend in the temperature change may differ according to the cigarette type. Referring to FIG. 5, the first-type cigarette, the second-type cigarette, and the third-type cigarette are compared and described.

In detail, when the preheating is performed while the first-type cigarette 501 is inserted, the time from a point in time, when the temperature of the heater assembly 310 reaches the lower temperature limit T_{Lower}, to a point in time, when the temperature reaches the upper temperature limit T_{Upper}, may be relatively the shortest. Next, when the preheating is performed while the second-type cigarette 502 is inserted, the time from the point in time, when the temperature of the heater assembly 310 reaches the lower temperature limit T_{Lower}, to the point in time, when the temperature reaches the upper temperature limit T_{Upper}, may be longer than the time when the first-type cigarette 501 is inserted. Then, when the preheating is performed while the third-type cigarette 503 is inserted, the time from the point in time, when the temperature of the heater assembly 310 reaches the lower temperature limit T_{Lower}, to the point in time, when the temperature reaches the upper temperature limit T_{Upper}, may be relatively the longest.

For example, the first-type cigarette 501 may be the cigarette type of FIG. 2A that includes the tobacco medium element including the filter material impregnated with the nicotine liquid, the second-type cigarette 502 may be the cigarette type of FIG. 2B that includes the tobacco medium element including the tobacco granules, and the third-type cigarette 503 may be the cigarette type of FIG. 2C that includes the tobacco medium element including the solid tobacco material. As described, the cigarette type is distinguished based on the type of the tobacco medium element included in the cigarette.

The trend in the temperature change within the preset temperature range of the preheating section may be distinguished based on the type of the tobacco medium element. In other words, according to the type of the tobacco medium element included in the cigarette, gradient values indicating the trend in the temperature change within the preset temperature range of the preheating section may differ. Such a difference is made because the speed of heating the heater assembly 310 is different depending on whether the tobacco medium element is close to a liquid medium or a solid medium. Therefore, in the present embodiment, based on the principle that the temperature changes vary according to the cigarette types, it is possible to identify which type of cigarette is currently inserted into the aerosol generating device 10.

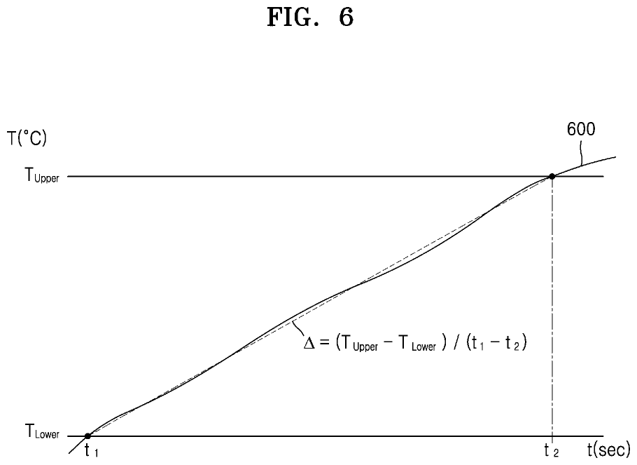

FIG. 6 is a diagram for explaining a method of calculating a gradient value corresponding to a trend in a temperature change within a preset temperature range in a preheating section, according to an embodiment.

Referring to FIG. 6, the controller 120 determines a point in time t₁ when a temperature 600 of the heater assembly 310 reaches a lower temperature limit T_{Lower} Of a preset temperature range. As preheating continues, the controller 120 determines a point in time t₂ when the temperature 600 of the heater assembly 310 reaches an upper temperature limit T_{Lower} of the preset temperature range. When the points in time t₁ and t₂ are determined, the controller 120 calculates a gradient value Δ according to Equation 1 below.

$$\\ \begin{matrix}Δ = ( {T}_{Upper} - {T}_{Lower} ) / ( {t}_{1} - {t}_{2} ) & [ Equation 1 ]\end{matrix}$$

The gradient value Δ calculated according to Equation 1 is a value indicating a trend in a temperature change in a preset temperature range in a preheating section according to material characteristics of a tobacco medium element included in a cigarette and may be used as a criterion for determining the cigarette type.

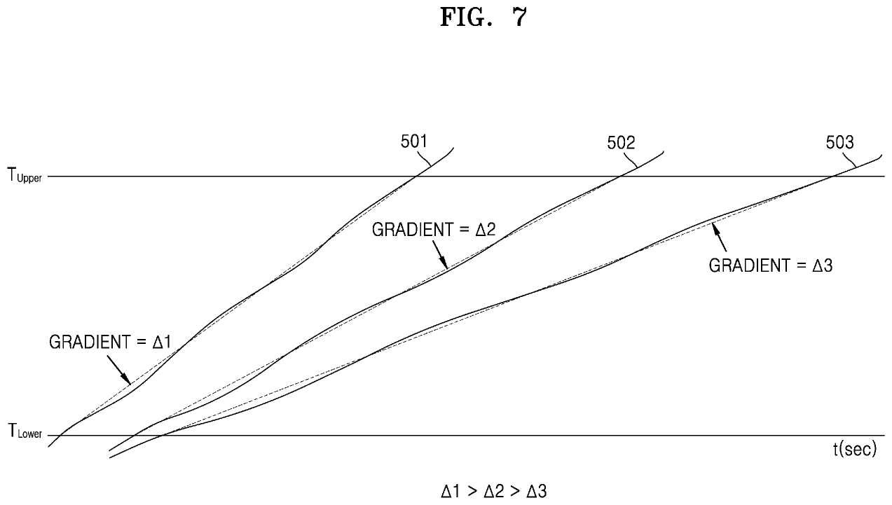

FIG. 7 is a diagram for explaining that gradient values differ depending on cigarette types within a preset temperature range in a preheating section, according to an embodiment.

FIG. 7 shows a gradient Δ1 of the first-type cigarette 501, a gradient Δ2 of the second-type cigarette 502, and a gradient Δ3 of the third-type cigarette 503, all of which are calculated within the preset temperature range between the lower temperature limit T_{Lower} and the upper temperature limit T_{Upper} in the preheating section. Here, different cigarette types may have different gradient values, for example, Δ1>Δ2>Δ3.

The controller 120 may identify the cigarette type by determining which of the gradient values, which are distinguished for each cigarette type, the gradient value corresponding to the trend in the temperature change falls within.

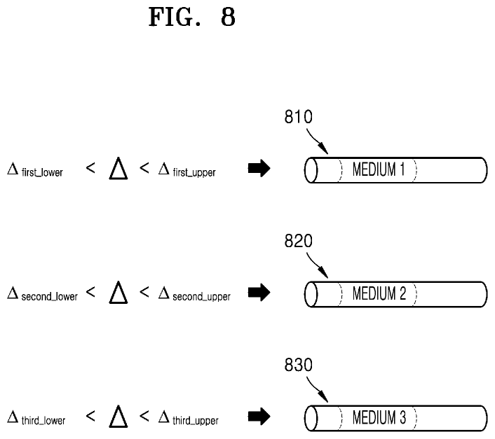

FIG. 8 is a diagram for explaining a method of identifying a cigarette type by using a gradient value corresponding to a trend in a temperature change, according to an embodiment.

Referring to FIG. 8, the controller 120 may determine which one of the three cigarette types the cigarette belongs to, based on a gradient value Δ that is currently output. The controller 120 determines which of the gradient ranges, distinguished for each cigarette type, the gradient value falls within.

For example, a first gradient range corresponding to a first-type cigarette 810 including a medium 1 may be a range including gradient values between a gradient Δ_{first_lower} and a gradient Δ_{first_upper}. A second gradient range corresponding to a second-type cigarette 820 including a medium 2 may be a range including gradient values between a gradient Δ_{second_lower} and a gradient Δ_{second_upper}. A third gradient range corresponding to a third-type cigarette 830 including a medium 3 may be a range including gradient values between a gradient Δ_{third_lower} and a gradient Δ_{third_upper}. Here, the first to third gradient ranges may not overlap each other.

Referring to FIG. 8, the first-type cigarette 810 including the medium 1 may be the cigarette type of FIG. 2A that includes the tobacco medium element including the filter material impregnated with the nicotine liquid, the second-type cigarette 820 may be the cigarette type of FIG. 2B that includes the tobacco medium element including the tobacco granules, and the third-type cigarette 830 may be the cigarette type of FIG. 2C that includes the tobacco medium element including the solid tobacco material. Accordingly, the third gradient range may include gradient values less than those in the second gradient range, and the second gradient range may include gradient values less than those in the first gradient range.

The controller 120 determines which one of the first to third gradient ranges the current gradient value Δ falls within. When the gradient value Δ is included in the first gradient range, the controller 120 identifies that the inserted cigarette is the first-type cigarette.

According to the method described above, the controller 120 may identify the cigarette type by determining the gradient range including the gradient value.

In the present embodiments, the cigarette types are identified using the cigarettes 21, 22, and 23 of FIGS. 2A to 2C. However, as another example, the present embodiment may be implemented to identify a cigarette type from two types of cigarettes (e.g., a liquid-medium cigarette and a solid-medium cigarette) or from at least four types of cigarettes. Alternatively, the present embodiment may also be implemented as a method of identifying cigarettes including other solid tobacco materials, for example, cut tobacco media, sheet tobacco media, or reconstituted tobacco media, even if cigarettes include the same solid medium. That is, according to the present embodiment, when the cigarette includes different tobacco medium elements, the cigarette type may be identified by determining the trend (that is, the gradient) in the temperature change within a predefined specific temperature range in the preheating section.

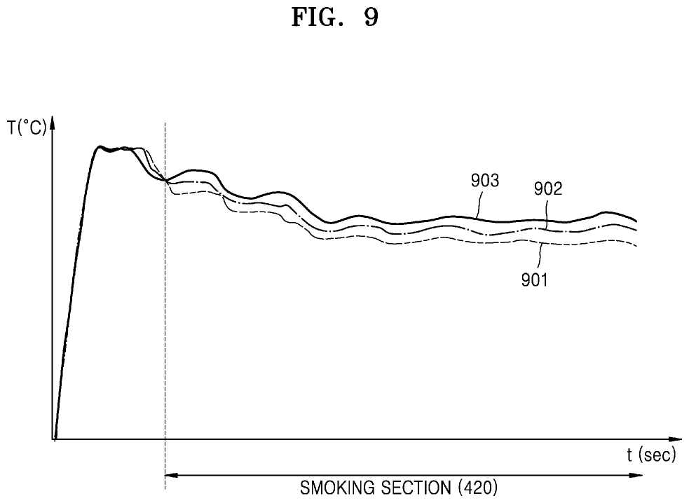

FIG. 9 is a diagram for explaining that the heating of a heater assembly is controlled in a smoking section by using a temperature profile corresponding to an identified cigarette type, according to an embodiment.

The controller 120 controls the heating of the heater assembly in the smoking section 420 by using the temperature profile corresponding to the identified cigarette type. In other words, the heating of the heater assembly in the smoking section 420 may be controlled with temperature profiles that vary according to cigarette types. Here, the temperature profiles varying according to the cigarette types may be stored in advance in the memory 150, and the controller 120 may load required temperature profiles from the memory 150 to control the heating of the heater assembly 310.

FIG. 9 shows that, in the smoking section 420, the heating is controlled with the temperature profiles varying according to the cigarette types. For example, the heating of the heater assembly 310 may be controlled using a first temperature profile 901 for a first-type cigarette, a second temperature profile 902 for a second-type cigarette, and a third temperature profile 903 for a third-type cigarette. For example, in the smoking section 420, target temperatures of the first temperature profile 901 may be lower than those of the third temperature profile 903. This is because the vaporization temperature of a liquid is lower than that of a solid under the assumption that the first-type cigarette includes a tobacco medium element including a filter material impregnated with a nicotine liquid and the third-type cigarette includes a tobacco medium element with a solid tobacco material.

That is, according to the present embodiment, because the heating of the heater assembly may be controlled in the smoking section under heating conditions of temperature profiles, in which target temperatures optimized for each cigarette type are set, a smoking sensation desired by the user for each cigarette type may be satisfied.

The controller 120 determines a temperature profile corresponding to the cigarette type that is identified before the temperature of the heater assembly 310 reaches a target preheating temperature of the preheating section. Accordingly, FIG. 9 shows that distinct temperature profiles are applied to different cigarette types after the smoking section 420 starts. However, one or more embodiments are not limited thereto, and the controller 120 may differently apply temperature profiles according to the cigarette types in some remaining preheating sections after the identification of the cigarette type. For example, a period of time, when the temperature is constantly maintained after the temperature reaches the target preheating temperature and before the smoking section starts, may vary for each cigarette type. That is, according to the present embodiment, when the cigarette type is identified, the control of the heating may be performed by applying different temperature profiles for each cigarette type to at least one of the preheating section and the smoking section after the above period of time.

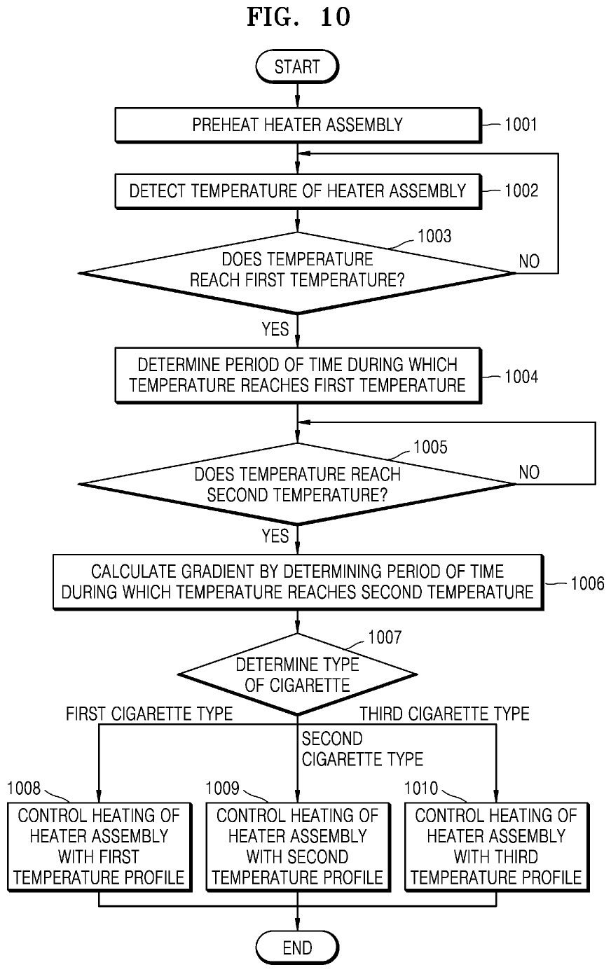

FIG. 10 is a detailed flowchart of a method of controlling an aerosol generating device, according to an embodiment; and

The method of FIG. 10 corresponds to operations that are time-serially processed by the aerosol generating device 10 described above with reference to the attached drawings. Therefore, even if omitted below, the descriptions described above with reference to the attached drawings may be applied to the method of FIG. 10.

In operation 1001, the controller 120 preheats the heater assembly 310 to generate an aerosol from a cigarette inserted into the aerosol generating device 10. The preheating may be initiated through the detection of the cigarette insertion by a cigarette detecting element or an external user input.

The heater assembly 310 may be preheated as a great amount of power is instantaneously supplied from the battery 110 to the heater assembly 310.

In operation 1002, the temperature sensor 140 senses the temperature of the heater assembly 310 that changes in the preheating section.

In operation 1003, the controller 120 determines whether the temperature of the heater assembly 310 reaches a first temperature that is the lower temperature limit in the preset temperature range T_{Lower}. When it is determined that the temperature of the heater assembly 310 is lower than the first temperature, operation 1002 resumes. However, when it is determined that the temperature of the heater assembly 310 reaches the first temperature, operation 1004 proceeds.

In operation 1004, the controller 120 determines a point in time t₁ when the temperature reaches the first temperature.

In operation 1005, the controller 120 determines whether the temperature of the heater assembly 310 reaches a second temperature that is the upper temperature limit in the preset temperature range T_{Upper}. When it is determined that the temperature of the heater assembly 310 is lower than the second temperature, the temperature sensor 140 keeps monitoring the temperature of the heater assembly 310. However, when it is determined that the temperature of the heater assembly 310 reaches the second temperature, operation 1006 proceeds.

In operation 1006, the controller 120 may determine the point in time t₂ in which the temperature reaches the second temperature and thus calculates a gradient corresponding to a trend in a temperature change in the preset temperature range in the preheating section. In this case, the gradient may be calculated according to Equation 1 described above.

In operation 1007, the controller 120 may identify a cigarette type by determining which one of the gradient ranges, which are distinguished for each cigarette type, the gradient belongs to. For example, a determination is made regarding which one of the three cigarette types is the aforementioned cigarette type. When it is determined that the calculated gradient is included in the first gradient range corresponding to the first-type cigarette, the controller 120 determines that the cigarette type is the first-type cigarette, and thus, operation 1008 proceeds. When it is determined that the calculated gradient is included in the second gradient range corresponding to the second-type cigarette, the controller 120 determines that the corresponding cigarette type is the second-type cigarette, and thus, operation 1009 proceeds. When it is determined that the calculated gradient is included in the third gradient range corresponding to the third-type cigarette, the controller 120 determines that the corresponding cigarette type is the third-type cigarette, and thus, operation 1010 proceeds.

In operation 1008, when the cigarette type is identified as the first-type cigarette, the controller 120 controls the heating of the heater assembly 310 with the first temperature profile during the smoking section for the first-type cigarette.

In operation 1009, when the cigarette type is identified as the second-type cigarette, the controller 120 controls the heating of the heater assembly 310 with the second temperature profile during the smoking section for the second-type cigarette.

In operation 1010, when the cigarette type is identified as the third-type cigarette, the controller 120 controls the heating of the heater assembly 310 with the third temperature profile during the smoking section for the third-type cigarette.

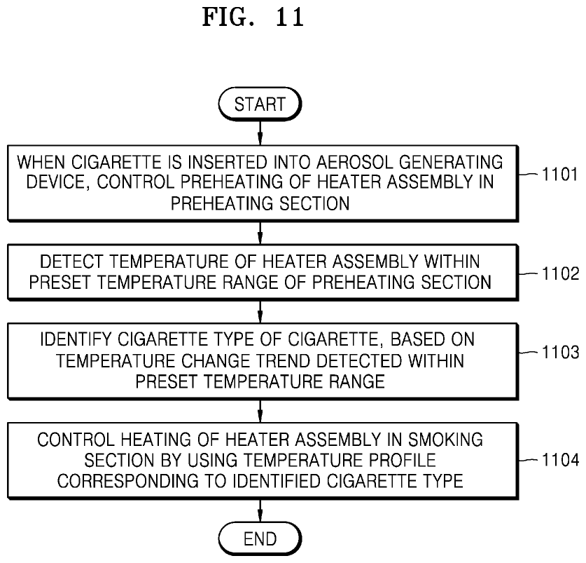

FIG. 11 is a flowchart of a method of controlling an aerosol generating device, according to an embodiment.

The method of FIG. 11 corresponds to operations that are time-serially performed by the aerosol generating device 10 described above with reference to the attached drawings. Therefore, even if emitted herein, the descriptions provided above with reference to the attached drawings may also be applied to the method of FIG. 11.

In operation 1101, when a cigarette is inserted into the aerosol generating device 10, the controller 120 controls the heating of the heater assembly 310 in the preheating section.

In operation 1102, the temperature sensor 140 senses the temperature of the heater assembly 310 within the preset temperature range of the preheating section.

In operation 1103, the controller 120 identifies a cigarette type of the cigarette, based on a trend in a temperature change sensed within the preset temperature range.

In operation 1104, the controller 120 may use a temperature profile corresponding to the identified cigarette type to control the heating of the heater assembly 310 for a smoking section.

The method described above may be composed as a program that is executable by a computer and may be implemented by a general-purpose digital computer for operating the program by using a non-transitory computer-readable recording medium. Also, a data structure used in the method described above may be recorded on the computer-readable recording medium by using various elements. The computer-readable recording medium includes a storage medium, such as a magnetic storage medium (for example, ROM, RAM, USB, a floppy disk, a hard disk, etc.) and an optical reading medium (for example, a CD-ROM, a DVD, etc.)

One of ordinary skill in the art pertaining to the present embodiments can understand that various changes in form and details can be made therein without departing from the scope of the characteristics described above. The disclosed methods should be considered in a descriptive sense only and not for purposes of limitation. The scope of the present embodiments is not reflected in the descriptions above and is reflected in the claims, and all differences within the equivalent scope shall be interpreted to be included in the present embodiments.

According to the one or more embodiments, in an aerosol generating device, a cigarette type may be identified and the heating of a heater assembly may be controlled using a temperature profile, in which target temperatures tailored to each cigarette type, without a separate user input, and thus, a smoking sensation optimized for each cigarette type may be provided to a user.

What is claimed is:

1. An aerosol generating device comprising:
a heater assembly configured to, when a cigarette is inserted into the aerosol generating device, heat the cigarette to generate an aerosol during a preheating section and a smoking section after the preheating section;
a temperature sensor configured to sense a temperature of the heater assembly in the preheating section and the smoking section; and
a controller configured to identify a cigarette type of the cigarette, based on a trend in a temperature change detected within a preset temperature range of the preheating section and control heating of the heater assembly during the smoking section by using a temperature profile corresponding to the identified cigarette type.

2. The aerosol generating device of claim 1, wherein the controller is further configured to determine the trend in the temperature change, based on a period of time during which the temperature of the heater assembly is increased from a first temperature to a second temperature in the preheating section, and
the second temperature is lower than a target preheating temperature of the preheating section.

3. The aerosol generating device of claim 1, wherein the controller is further configured to identify the cigarette type by determining which of a plurality of gradient ranges, which are distinguished for each cigarette type, a gradient value corresponding to the trend in the temperature change falls within.

4. The aerosol generating device of claim 1, wherein the controller is further configured to, when the gradient value corresponding to the trend in the temperature change falls within a first gradient range, identify the cigarette as a first-type cigarette, when the gradient value falls within a second gradient range, identify the cigarette as a second-type cigarette, and when the gradient value falls within a third gradient range, identify the cigarette as a third-type cigarette, and
the first-type cigarette comprises a cigarette type comprising a tobacco medium element comprising a filter material impregnated with a nicotine liquid, the second-type cigarette comprises a cigarette type comprising a tobacco medium element comprising tobacco granules, and the third-type cigarette comprises a cigarette type comprising a tobacco medium element comprising a solid tobacco material.

5. The aerosol generating device of claim 4, wherein the third gradient range comprises a plurality of gradient values less than those in the second gradient range, and
the second gradient range comprises a plurality of gradient values less than those in the first gradient range.

6. The aerosol generating device of claim 1, wherein the controller is further configured to determine a temperature profile corresponding to the identified cigarette before the temperature of the heater assembly reaches a target preheating temperature of the preheating section.

7. The aerosol generating device of claim 1, wherein the controller is further configured to control preheating of the heater assembly by supplying a preset amount of power to the heater assembly, regardless of cigarette types, until the temperature of the heater assembly reaches an upper temperature limit within the preset temperature range in the preheating section.

8. The aerosol generating device of claim 1, wherein the cigarette type is distinguished according to a type of a tobacco medium element in the cigarette, and
the trend in the temperature change is distinguished according to the type of the tobacco medium element.

9. The aerosol generating device of claim 1, wherein the controller is further configured to control the heating of the heater assembly with temperature profiles that differ according to the cigarette type, in the smoking section.

10. The aerosol generating device of claim 1, wherein the preset temperature range comprises a temperature range from about 200° C. to about 270° C.

11. A method of controlling an aerosol generating device, the method comprising:
when a cigarette is inserted into the aerosol generating device, controlling preheating of a heater assembly in a preheating section;
sensing a temperature of the heater assembly within a preset temperature range of the preheating section;
identifying a cigarette type of the cigarette, based on a trend in a temperature change detected within the preset temperature range; and
controlling heating of the heater assembly in a smoking section by using a temperature profile corresponding to the identified cigarette type.

12. The method of claim 11, further comprising determining the trend in the temperature change, based on a period of time during which the temperature of the heater assembly increases from a first temperature to a second temperature in the preheating section,
wherein the second temperature is lower than a target preheating temperature of the preheating section.

13. The method of claim 11, wherein the identifying comprises identifying the cigarette type by determining which of a plurality of gradient ranges, which are distinguished for each cigarette type, a gradient value corresponding to the trend in the temperature change falls within.

14. The method of claim 11, further comprising determining a temperature profile corresponding to the identified cigarette before the temperature of the heater assembly reaches a target preheating temperature of the preheating section.

15. The method of claim 11, wherein the cigarette type is distinguished according to a type of a tobacco medium element in the cigarette,
the trend in the temperature change is distinguished according to the type of the tobacco medium element,
when the gradient value corresponding to the trend in the temperature change falls within a first gradient range, the cigarette is identified as a first-type cigarette, when the gradient value falls within a second gradient range, the cigarette is identified as a second-type cigarette, when the gradient value falls within a third gradient range, the cigarette is identified as a third-type cigarette, and
the third gradient range comprises a plurality of gradient values less than those in the second gradient range, and the second gradient range comprises a plurality of gradient values less than those in the first gradient range.
